(19) United States
(12) Patent Application Publication
(10) Pub. No.: US 2026/0228417 A1
(43) Pub. Date: Aug. 6, 2026

(54) CONTENT GENERATION USING TARGET KEYWORDS FOR PERFORMANCE OPTIMIZATION

(71) Applicant: Adobe Inc., San Jose, CA (US)

(72) Inventors: Ashutosh Shroti, Noida (IN); Abhinav Saraswat, Noida (IN); Ritwik Srivastava, Noida (IN); Dhaval Kumar, Noida (IN); Sneh Arora, Delhi (IN); Varun Bhatia, Delhi (IN)

(21) Appl. No.: 19/042,354

(22) Filed: Jan. 31, 2025

(51) Int. Cl. G06F 40/14; G06F 3/0481; G06F 16/2457; G06F 16/9538

(52) U.S. Cl. CPC G06F 40/14; G06F 3/0481; G06F 16/24578; G06F 16/9538

(57) ABSTRACT

Methods, computer systems, computer storage media, and graphical user interfaces are provided for facilitating content generation using target keywords for performance optimization. In one implementation, a set of search result rankings for a target website and one or more competitors of the target website in association with a set of keywords are obtained. Thereafter, candidate performant keywords are identified based on a comparison of search result rankings for the target website and search result rankings for the one or more competitors. The candidate performant keywords, or a portion thereof, are used to generated content data in association with the target website via one or more generative artificial intelligence (AI) models. Such content data can be presented via a display and/or incorporated into the target website.

### BACKGROUND

In the highly competitor digital landscape, business are frequently enhancing content to improve a website's competitive positioning. In this regard, businesses may frequently update content or generate new content and, in some cases, generation various content variations in an effort to optimize for effectiveness. For example, content variations may be created to target different sets or combinations of keywords and, as such, to optimize for a more effective website. In some cases, to determine which content variation would be most effective to attain a particular goal, each variation may be examined in relation to the particular goal. For example, assume different content variations are created for different keyword sets. To determine which content variation to use in association with a website, the different content variations may be tested in the market by measuring the success or obtaining feedback. Such a process is time-consuming and tedious. For example, in some cases, a content variation may be tested for several months in order to determine success of the content variation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating content generation using target keywords for performance optimization. In particular, embodiments are directed to an automated manner for identifying target keywords and using such target keywords to generate content data in association with a website. As described herein, target keywords are identified based on a comparative analysis of a target website with competitors' websites in an effort to improve the target website's competitor positioning. Such identified target keywords for a website may be identified in an effective and efficient manner and seamlessly used to create content that corresponds therewith, thereby enabling efficient and timely content generation that facilitates performance optimization for the website, for example, to improve search result rankings. Further, the generated content data may be seamlessly integrated with or incorporated into the website. Such technical enhancements reduce manual effort and ensure timely and consistent content enhancements as well as improve a website's competitive positioning based on comparative analysis with competitor's websites.

### BRIEF DESCRIPTION OF THE DRAWINGS

The technology described herein is described in detail below with reference to the attached drawing figures, wherein:

FIG. 1 is a block diagram of an exemplary system for facilitating content generation for performance optimization, suitable for use in implementing aspects of the technology described herein;

FIG. 2 is an example implementation for facilitating content data generation for performance optimization, in accordance with aspects of the technology described herein;

FIG. 3 provides an example of a set of competitor keywords, in accordance with embodiments described herein;

FIG. 4 provides example data obtained using an API endpoint, in accordance with embodiments described herein;

FIG. 5 provides example performance data, in accordance with embodiments described herein;

FIG. 6 provides another example of keyword performance data, in accordance with embodiments described herein;

FIG. 7 provides an example of candidate performant keywords, in accordance with embodiments described herein;

FIG. 8 provides another example of candidate performant keywords, in accordance with embodiments described herein;

FIG. 9 provides on example of a content generation prompt, in accordance with embodiments described herein;

FIG. 10 provides one example of generated content data, in accordance with embodiments described herein;

FIG. 11 provides one example method flow for facilitating content generation for performance optimization, in accordance with embodiments described herein;

FIG. 12 provides another example method flow for facilitating content generation for performance optimization, in accordance with embodiments described herein;

FIG. 13 provides another example method flow for facilitating content generation for performance optimization, in accordance with embodiments described herein; and

FIG. 14 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Content variations associated with websites may be created in an effort to effectuate a more effective content. For instance, to identify a better performing website that results in higher rankings on a search results page, content variations may be created and analyzed, for example, via A/B testing. Oftentimes, such content variations experiment with different keyword usage and placement (e.g., titles, headings, body text, etc.). To determine which content variation to use in association with a website to achieve better performance, the different content variations may be tested in the market by measuring the success or obtaining feedback. Such a process is time-consuming and tedious. For example, in some cases, a content variation may be tested for several months in order to determine performance of the content variation. Such results may then be manually analyzed to determine which content variation is most likely to attain the designated goal.

Accordingly, unnecessary computing resources are utilized to analyze the content variations generated in accordance with a website. For example, computing and network resources are unnecessarily consumed in an effort to facilitate providing the content variations to individuals such that success and/or feedback associated with the content variations may be analyzed. For instance, computer input/output operations are unnecessarily increased in order to initiate provision of multiple content variations to different users over an extended amount of time in order to evaluate success of the different content variations as each content variation requires a significant amount of computer input/output operations related to serving the corresponding content variation. Further, as content is communicated over a network, initiating multiple content variations over an extended period of time to obtain feedback decreases the throughput for the network, increases the network latency, and increases packet generation costs. Additionally, analyzing the feedback in relation to the multiple content variations unnecessarily consumes computing resources. For example, the feedback results must be stored for the duration of the test period for many different content variations. As another example, the feedback results may be manually analyzed and/or analyzed throughout the duration of the test period, thereby unnecessarily consuming computing and network resources.

In some cases, conventional tools may be used to facilitate analysis of variations of content. For example, conventional tools may be used to provide recommendations related to website optimization. With such conventional tools, however, initial content is generated in advance such that it can be analyzed by the tools. Accordingly, various computing resources are used to generate and store one or more content variations to be analyzed. Further, based on any output recommendations, the user manually implements (in a separate process) any updates or changes in accordance with a recommendation. In this way, additional computing resources are used to facilitate the manual implementation of changes in association with a website, which may occur over numerous iterations of updates. In addition to the various consumed computing resources used to integrate any recommendations to website content, such a process also is time-consuming, requires separate efforts to apply changes, and oftentimes results in untimely and inconsistent updates.

As such, embodiments described herein are directed to facilitating content generation using target keywords for performance optimization. In particular, embodiments are directed to an automated manner for identifying target keywords and using such target keywords to generate content data in association with a website. As described herein, target keywords are identified based on a comparative analysis of a target website with competitors'websites in an effort to improve the target website's competitor positioning. Such identified target keywords for a website may be identified in an effective and efficient manner and seamlessly used to create content that corresponds therewith, thereby enabling efficient and timely content generation that facilitates performance optimization for the website, for example, to improve search result rankings. Further, the generated content data may be seamlessly integrated with or incorporated into the website. Such technical enhancements reduce manual effort and ensure timely and consistent content enhancements as well as improve a website's competitive positioning based on comparative analysis with competitor's websites.

At a high level, candidate performant keywords that may be used to facilitate content generation are identified. A candidate performant keyword generally has the potential to increase performance for a website, such as to increase search result rankings, clicks, conversions, etc. In embodiments, candidate performant keywords that are identified to facilitate content data generation generally represent keywords that may be opportunities for optimizing performance of the content. For instance, a candidate performant keyword(s) may represent a gap or missing aspect of existing content data associated with a website such that, if added to the existing content data, may result in higher performing content. As such, identifying keywords that competitors are ranking for but a particular website is not yet targeting or results in a lower ranking, which may be referred to as keyword gaps, presents an opportunity to optimize content to fill such gaps. Candidate performant keywords may be identified in various manners. As one example, in accordance with identifying a set of competitors to a target website, keywords used by the competitors may be identified, and a comparative analysis of rankings associated with keywords may be performed in association with the target website and corresponding competitors to identify keyword gaps therebetween. For example, assume for a particular keyword, the target website has a ranking of “10,” and the competitor rankings are “2,” “4,” and “7.” In such a case, the particular keyword may be recognized as a candidate performant keyword as using such a keyword may increase the performance of the target website.

In accordance with identifying a set of candidate performant keywords for a particular website, in some cases, the candidate performant keywords may be presented. In this way, a user may view the recommendations and performance data associated. In cases in which the user desires to use the recommended candidate performant keywords, or a portion thereof, the user may select to generate content using such keywords. In other cases, the identified candidate performant keywords may be automatically used (e.g., without user selection) to generate content data. Content data to generate may include any type of content associated with a webpage or website. Various types of content data include content text, meta tags, header tags, image content, URLs, internal linkings, schema markups, etc.

To generate content data, a content generation prompt may be generated to input into one or more artificial intelligence (AI) models, such as an LLM. The content generation prompt may include one or more of the candidate performant keywords identified as target keywords to use to generate content data. Accordingly, the content generation model can use the indicated target keyword(s) in the prompt and generate content data that includes the target keywords. In some cases, a single prompt may be used to generate multiple types of content data. In other cases, multiple prompts may be used to generate multiple types of content data. Further, content data generation may occur in an iterative manner. For example, in some cases, content text may initially be generated and, thereafter, a URL may be generated using the generated content text. Using AI technology, such as an LLM, effective or performant content data can be generated in an efficient and timely manner. Upon generating the content data, such content data may be presented to a user and/or implemented to update the target website accordingly.

Advantageously, embodiments described herein integrate content analysis and content generated in an automated manner, thereby directly translating competitive analysis into actional content data updates and eliminating various manual aspects otherwise needed. Further, such an implementation facilitates a timely and consistent content creation and integration to improve website performance, such as competitive positioning. Further, embodiments described herein provide a scalable, timely, and efficient solution. In particular, using AI techniques, such as an LLM, enables an efficient generation of content data that is likely to result in success. Further, as modification(s) to keyword rankings occurs, the techniques provided herein provide for timely evaluation of the modification(s) as well as generation and implementation of effective content data to account for the changes in rankings. In this way, a website content is generated and integrated in a timely and consistent manner.

In addition, embodiments described herein provide an enhanced and intuitive user experience. In particular, in accordance with selecting to evaluate a keywords utilization, the user is presented with helpful and accurate insights. For example, various keywords that may fill a void or gap in rankings of a website in comparison to competitors may be presented and, in a seamless manner, the user may select to use such keywords to efficiently generate new content data that reflects the desired keywords. In this way, suitable website content is timely identified and may be more efficiently implemented to achieve designated goals.

Advantageously, efficiencies of computing and network resources can be enhanced using implementations described herein. In particular, generating content using target keywords in association with AI technology provides for a more efficient use of computing resources (e.g., less computationally expensive, fewer input/output operations, higher throughput and reduced latency for a network, fewer packet generation costs, etc.) than conventional methods that require an extensive duration for testing and a manual analysis of such test results, which is exacerbated with the extensive amount of content that can be created using AI technology. In this regard, the technology described herein enables identification of target keywords using a comparative analysis in an efficient and effective manner and seamlessly generating content using the target keywords to increase website performance, thereby reducing unnecessary computing resources used to initiate multiple content creations to explore different keywords and combinations thereof. Further, the technology described herein conserves network resources, as various content need not be served to an extensive number of individuals over a lengthy duration of time to evaluate the content, which results in higher throughput, reduced latency, and lower packet generation costs as fewer packets are sent over the network.

Various terms are used throughout the description of embodiments provided herein. A brief overview of such terms and phrases is provided here for ease of understanding, but more details of these terms and phrases are provided throughout.

An entity may be any object or subject that can be recognized by a search engine such that it may be ranked or positioned among search results. In embodiments, an entity is a website, or a web page. In alternative or additional embodiments, an entity represents a person(s), a place(s), a product, an event, an organization, a rich result, a video, an image, a local listing, a map, a news article, an application, a document, a podcast, a social media post, etc.

A target entity refers to an entity, such as a website, that is a target of an analysis or operation. A target entity may be an entity to analyze, that is being analyzed, for which to generate content, for which to integrate content, and/or the like. In cases in which the entity is a website, the target entity may be referred to as a target website.

A competitor generally refers to a competitor of the target entity. For example, in cases in which a target entity is a website, a competitor may be a competitor website.

A competitor keyword refers to a keyword used by a competitor. For example, a competitor keyword may be a keyword used or included in association with a competitor website. A keyword generally refers to a word or phrase. Keywords may be used in various ways to ensure that content aligns with a search(es).

A candidate performant keyword refers to a keyword that is a candidate to become performant for a particular entity (e.g., website, webpage, etc.). As such, a candidate performant keyword has the potential or possibility to increase performance for an entity (e.g., increase or improve search result rankings, clicks, conversions, etc.). Generally, candidate performant keywords that are identified to facilitate content data generation generally represent keywords that may be opportunities for optimizing performance of the content. For example, in embodiments, a candidate performant keyword(s) may represent a gap or missing aspect of existing content data associated with a particular entity, such that, if added to the existing content data, may result in high performing content (e.g., a higher search results ranking). A candidate performant keyword may be in the form of a gap keyword.

A gap keyword generally refers a keyword that is missing from a target entity's content or associated with a lower search result ranking for the target entity, but appear or have a higher search result ranking in association with a competitor(s).

A target keyword generally refers to a keyword desired or targeted to use for content data generation. A target keyword may be an identified candidate performant keywords. In some cases, the identified candidate performant keywords are used as target keywords. In other cases, a subset or portion of the identified candidate performant keywords are used as target keywords. For instance, a set of candidate performant keywords may be presented to a user and, based on a user selectin of a portion of the candidate performant keywords, the selected portion of candidate performant keywords are used as target keywords for content data generation.

Content data generally refers to any data associated with content. In this regard, content data may include text content, meta tags, URL, header tags, images, schema markup, internal linking, etc.

A ranking or position ranking for an entity, such as a website, generally refers to where the particular entity appears in a search engine results page for a given keyword. Generally, a tope result is in position 1 and subsequent results follow in numerical order. The higher the position or ranking, the most likely the entity is to receive traffic as users typically click on top results.

### Overview of Exemplary Environments for Facilitating Content Generation Using Target Keywords for Performance Optimization

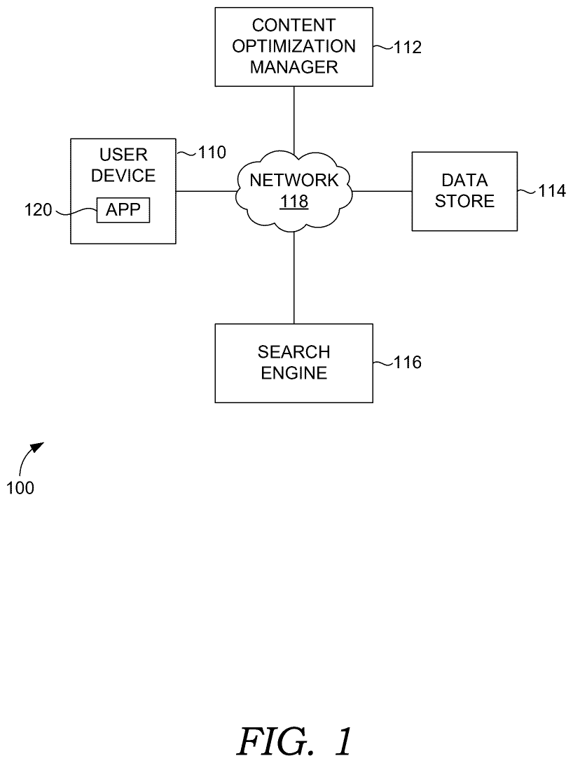

Referring initially to FIG. 1, a block diagram of an exemplary network environment 100 suitable for use in implementing embodiments described herein is shown. Generally, the system 100 illustrates an environment suitable for facilitating content generation for performance optimization, such as search engine results performance optimization. Among other things, embodiments described herein effectively and efficiently generate content using identified target keywords to improve performance. The target keywords are generally identified as gap keywords. In this regard, the gap keywords may be keywords that are missing from a target entity's content or associated with a lower search result ranking for the target entity, but appear or have a higher search result ranking in association with a competitor(s). Such content generated may be provided as a recommendation and/or utilized in association with a website. Thereafter, the website, including the content generated using target keywords, can be analyzed and used in ranking search results associated with the content.

In operation, a user, such as a marketer, can input or select to analyze an entity, such as a website or webpage, and, based on the input, be automatically provided with one or more target keywords and/or content data that incorporates one or more target keywords to facilitate search performance optimization. In particular, ranking of a target entity may be compared to rankings of competitors in association with a set of keywords to identify candidate performant keywords to use in generating content. In this way, candidate performant keywords that may facilitate improvement of performance of a website may be identified (e.g., based on a discrepancy of a ranking between the target entity and a competitor(s)). The candidate performant keywords, or a portion thereof, can be used as target keywords to generate various types of content data, such as text content (e.g., an article or paragraph), meta tags, URLs, headers, image content, schema markup, internal linking, and/or the like. As such, when the improved or enhanced content is incorporated or implemented into a website, the website performance (e.g., ranking) improves.

The network environment 100 includes a user device 110, a content optimization manager 112, a data store 114, and a search engine 116. The user device 110, the content optimization manager 112, the data store 114, and the search engine 116 can communicate through a network 118, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the content optimization manager 112 and/or data store 114 may be integrated with the user device 110 and/or search engine 116. For instance, a portion of the content optimization manager 112 may be integrated with user device 110 and/or search engine 116, while another portion of the content optimization manager 112 may be integrated with the user device 110 and/or search engine 116.

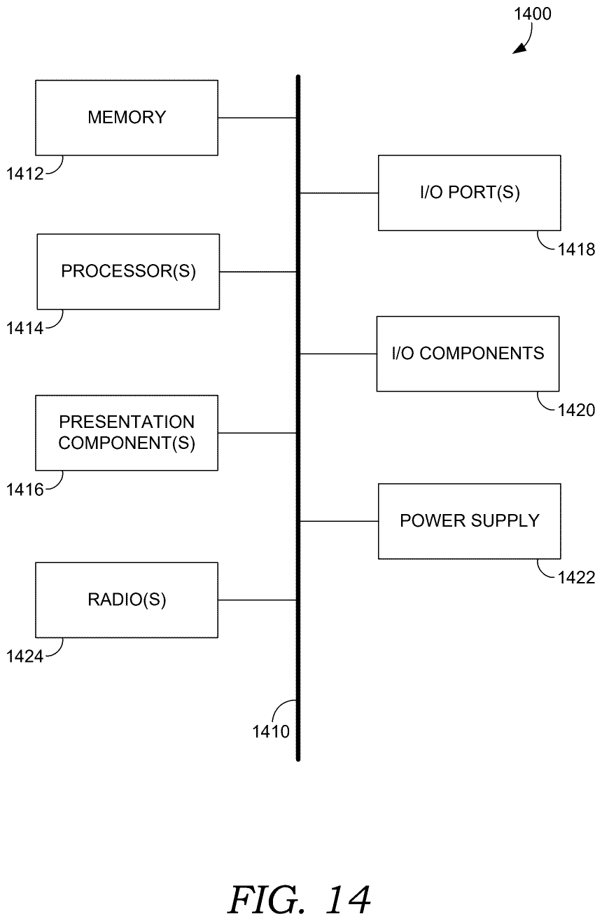

The user device 110 can be any kind of computing device capable of facilitating content generation using target keywords for search performance optimization. For example, in an embodiment, the user device 110 can be a computing device such as computing device 1400, as described above with reference to FIG. 14. In embodiments, the user device 110 can be a personal computer (PC), a laptop computer, a workstation, a mobile computing device, a personal digital assistant (PDA), a cell phone, or the like. Although illustrated separately, in some cases, the functionality described in association with the user device 110 may be performed via a single device.

The user device 110 can include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating content generation for performance optimization, such as search result performant operation. In some cases, the application(s), such as application 120, may facilitate initiating and/or viewing of competitor insights (e.g., candidate performant keywords) and/or content generated in association therewith. In some implementations, the application(s) comprises a web application, which can run in a web browser, and could be hosted at least partially server-side (e.g., via content optimization manager 112 or search engine 116). In addition, or instead, the application(s) can comprise a dedicated application. In some cases, the application is integrated into the operating system (e.g., as a service). As one specific example application, application 120 may be a content management tool and/or analytics tool (e.g., Adobe® Experience Cloud), or a portion thereof, that enables creation, management, delivery, and/or analysis of content and digital assets (e.g., websites). In some cases, such digital experience may be provided across various channels, such as websites, mobile apps, forms, electronic communications, etc. Application 120 may be accessed via a mobile application, a web application, or the like.

User device 110 can be a client device on a client-side of operating environment 100, while content optimization manager 112 and/or search engine 116 can be on a server-side of operating environment 100. Content optimization manager 112 and/or search engine 116 may comprise server-side software designed to work in conjunction with client-side software on user device 110 so as to implement any combination of the features and functionalities discussed in the present disclosure. An example of such client-side software is application 120 on user device 110. Alternatively, the user device 110 may include server-side software. This division of operating environment 100 is provided to illustrate one example of a suitable environment, and it is noted there is no requirement for each implementation that any combination of user device 110, content optimization manager 112, and/or search engine 116 remain as separate entities.

In an embodiment, the user device 110 is separate and distinct from the content optimization manager 112, the search engine 116, and the data store 114 illustrated in FIG. 1. In another embodiment, the user device 110 is integrated with one or more illustrated components. For instance, the user device 110 may incorporate functionality described in relation to the content optimization manager 112. For clarity of explanation, embodiments are described herein in which the user device 110, the content optimization manager 112, the data store 114, and the search engine 116 are separate, while understanding that this may not be the case in various configurations contemplated.

As described, a user device, such as user device 110, can facilitate initiating and/or viewing of competitor insights (e.g., candidate performant keywords) and/or content generated in association therewith. A user device 110, as described herein, is generally operated by an individual or set of individuals that desires to analyze or manage performance of one or more websites or domains, or portions thereof. As one example, a user device may be operated by a campaign manager or marketing manager. Such an individual may be affiliated with or a representative of a company associated with the campaign.

In some cases, identification of candidate performant keywords and/or content generation in association with an entity (e.g., a website) may be initiated at the user device 110. For example, a user, such as an administrator or campaign manager, may input, provide, or select to initiate or view competitor insights, such as candidate performant keywords, and/or generated content. For instance, a user may input or select, via a user interface, a particular website or domain and, thereafter, select to view competitor insights or candidate performant keywords. Based on such input, the resulting competitor insights or candidate performant keywords may be presented to the user via the user device 110. Additionally or alternatively, a user may input or select, via a user interface, to generate content. In some cases, one or more keywords of the candidate performant keywords may be automatically used to generate content including such keywords. In other cases, a user may select or confirm the particular keywords of candidate performant keywords desired to be used in generating content.

Although only a single user device 110 is illustrated in FIG. 1, any number of user devices may operate in this environment. For example, a first user device may initiate candidate performant keyword identification and/or content generation for a first website, while a second user device may initiate candidate performant keyword identification and/or content generation for a second website.

An input or selection (e.g., of an entity, domain, set of candidate performant keywords, etc.) can be provided via an application 120 operating on the user device 110. In this regard, the user device 110, via an application 120, might allow a user (e.g., an administrator) to input, select, or otherwise provide a selection of an entity for which competitor insights are desired to be viewed, a set of keywords, from presented candidate performant keywords, to use for generating content, and/or the like. The application 120 may facilitate input in a verbal form, a textual input form, a document form, etc. Further, data may be input at the user device 110 in any manner. For instance, upon accessing a particular application (e.g., a content management application), a user may be presented with, or navigate to, an input tool to input a website or domain for which to perform a competitive analysis (e.g., via text input) to enhance or improve the website (e.g., in search result rankings).

The user device 110 can communicate with the content optimization manager 112 to provide data and/or selections. In embodiments, for example, a user may utilize the user device 110 to provide a selection to analyze competitor data in association with a website via the network 118. As another example, a user may use the user device 110 to select a subset of candidate performant keywords to use for generating content. In some embodiments, the network 118 might be the Internet, and the user device 110 interacts with the content optimization manager 112. In other embodiments, for example, the network 118 might be an enterprise network associated with an organization. It should be apparent to those having skill in the relevant arts that any number of other implementation scenarios may be possible as well.

With continued reference to FIG. 1, the content optimization manager 112 can be implemented as server systems, program modules, virtual machines, components of a server or servers, networks, and the like. At a high level, the content optimization manager 112 manages optimization of content using one or more target keywords (e.g., gap keywords). In operation, and at a high level, the content optimization manager 112 can obtain an indication or selection to analyze a website and/or to generate content in association with the website, for example, from user device 110. Thereafter, a set of candidate performant keywords may be identified. In some cases, a set of candidate performant keywords is identified based on a comparison of ranking of a target entity (e.g., website) in association with a set of keywords relative to competitor rankings in association with the set of keywords. For keywords used by the competitor and not used by the target entity and/or for keywords for which the target entity has a lower ranking than its competitors, such keywords may be identified as candidate performant keywords. Such candidate performant keywords, or a portion thereof, may be presented to the user for viewing. Further, using AI models, such as an LLM, LVM, and/or MLLM, content data may be generated based on the one or more candidate performant keywords. In some cases, target keywords to use to generate content data may be automatically selected from candidate performant keywords. In other cases, target keywords to use to generate content data may be based on a user selection of one or more displayed candidate performant keywords. The content data that may be generated include content data, image data, internal linking, URLs, headers, etc. Generally, keywords, also referred to herein as target keywords, selected for use in generating content data are keywords (e.g., from a set of candidate performant keywords) that facilitate enhancing content such that it is more performant, such as, for example, by increasing search result rankings. In some cases, the generated content data may then be presented via the user interface and/or used to update or modify the website. In some cases, the content data may be automatically used to update or modify a website. In other cases, the generated content data may be presented, and a user may select whether or which content data to use to update a website. Such candidate performant keywords and/or generated content data can additionally or alternatively be transmitted to data store 114 for access by any component managing or executing a website or campaign associated therewith. Advantageously, utilizing implementations described herein enables generation of content that results in an increased performance in association with a search or search engine, such as search engine 116,

Search engine 116 is generally configured to execute searches, such as searches initiated via a search user (e.g., a user utilizing a search engine). A search engine enables users to search for information on the Internet by entering keywords, etc. A search engine uses algorithms to index, rank, and display relevant web pages based on the search query. At a high level, in accordance with submission of a search query, the search engine 116 uses a ranking algorithm to determine which indexed pages are the most relevant. The ranking algorithm may rank search results using keyword usage, among other things. Based on the rankings of the search results, the search engine 116 returns a list of search results, which may include a title, a brief description, and a link to the page. Advantageously, in accordance with embodiments described herein, for a website being analyzed, the content data associated with the website may be updated and improved using content generated based on one or more of the identified candidate performant keywords. In this way, the updated website may result in a higher search result ranking than resulted using the prior website version.

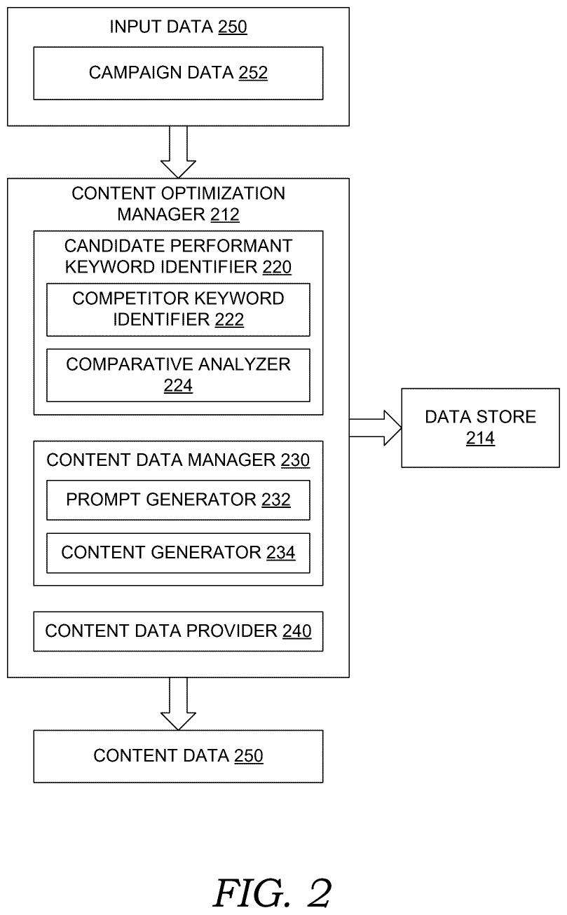

Turning now to FIG. 2, FIG. 2 illustrates an example implementation for facilitating content data generation for performance optimization via content optimization manager 212. The content optimization manager 212 can communicate with the data store 214. The data store 214 is configured to store various types of information accessible by the content optimization manager 212, or other server or component. In embodiments, a user device (such as user device 110 of FIG. 1), a search engine (such as search engine 116 of FIG. 1), and content optimization manager 212 can provide data to the data store 214 for storage, which may be retrieved or referenced by any such component. As such, the data store 214 may store candidate performant keywords, target keywords, content data, and/or the like.

In operation, the content optimization manager 212 is generally configured to facilitate or manage generation of content, and/or data associated therewith, for performance optimization. In embodiments, generation of content data is based on a comparative analysis. In particular, the content optimization manager 212 manages comparative analysis of keywords and utilization of such comparative analysis to generate effective content data. In this way, content data may be generated in an efficient and effective manner that optimizes performance of the content. In some embodiments, performance optimization may refer to search engine optimization. In this way, the positioning or ranking of content, such as a website, webpage, or other content (e.g., video, image, or other search result), in accordance with search results may improve.

In embodiments, the content optimization manager 212 includes a candidate performant keyword identifier 220, a content data manager 230, and a content data provider 240. According to embodiments described herein, the content optimization manager 212 can include any number of other components not illustrated. In some embodiments, one or more of the illustrated components 220, 230, and 240 can be integrated into a single component or can be divided into a number of different components. Components 220, 230, and 240 can be implemented on any number of machines and can be integrated, as desired, with any number of other functionalities or services.

The candidate performant keyword identifier 220 is generally configured to identify a set of candidate performant keywords for use in generating content data for a particular entity, which may also be referred to as a target entity. In this regard, for a particular entity, a set of candidate performant keywords may be identified that can be used to facilitate content generation. An entity may be any object or subject that can be recognized by a search engine such that it may be ranked or positioned among search results. In embodiments, an entity is a website, or a web page. In alternative or additional embodiments, an entity represents a person(s), a place(s), a product, an event, an organization, a rich result, a video, an image, a local listing, a map, a news article, an application, a document, a podcast, a social media post, etc.

A keyword generally refers to a word or phrase. Keywords may be used in various ways to ensure that the content aligns with a search associated with a user. In this way, keywords may be used or integrated into the content, such as a webpage or website. Additionally or alternatively, keywords may be used in a title tag, a meta description, headings, alternative text for images, images, URL structure, internal linking, external links (e.g., backlinks), tags and categories, schema markup, content optimization for latent semantic indexing, etc. Oftentimes, keywords are input (e.g., by a user) to search for content (e.g., information, products, services, etc.). A performant keyword generally refers to a keyword, that if used in content, optimizes performance of content (e.g., improve search result ranking associated with the content). In this regard, performant keywords are highly effective at driving relevant traffic to content (e.g., via a website), generating clicks, contributing to high rankings in search engine results page, and/or the like.

A candidate performant keyword refers to a keyword that is a candidate to become performant for a particular entity (e.g., website, webpage, etc.). As such, a candidate performant keyword has the potential or possibility to increase performance for an entity (e.g., increase or improve search result rankings, clicks, conversions, etc.). Generally, candidate performant keywords that are identified to facilitate content data generation generally represent keywords that may be opportunities for optimizing performance of the content. For example, in embodiments, a candidate performant keyword(s) may represent a gap or missing aspect of existing content data associated with a particular entity, such that, if added to the existing content data, may result in high performing content (e.g., a higher search results ranking). As such, identifying keywords that competitors are ranking for but a particular entity is not yet targeting or results in a lower ranking, also referred to as keyword gaps, presents an opportunity to optimize content (e.g., via content data generation) to fill such gaps.

The candidate performant keyword identifier 220 may identify candidate performant keywords in any of a number of ways. In one embodiment, candidate performant keywords for an entity are identified based on an analysis of competitor keywords. Competitor keywords refer to keywords used in competitor content. In some cases, competitor keywords may have been selected for inclusion in the competitor content based on relevance to user queries and/or search engine optimization goals associated with the competitor. As described herein, the candidate performant keyword identifier 220 may then use identified competitor keywords to perform a comparative analysis, such as a comparative analysis that compares the entity's keywords with keywords used by one or more competitors. As such, to identify candidate performant keywords, the candidate performant keyword identifier 220 may include a competitor keyword identifier 222 and a comparative analyzer 224.

Initially, the competitor keyword identifier 222 may identify competitor keywords. In some embodiments, identified competitor keywords may be performant or high-traffic keywords in association with the competitors. Understanding competitor keywords being targeted may provide valuable insights into competitor strategies and facilitate improving performance associated with a particular entity.

In some embodiments, the competitor keyword identifier 222 may identify a set of competitors for which to identify keywords. The particular competitor(s) for which to obtain keywords may be identified in any number of ways. As one example, a user may input a set of competitors for which keywords are to be analyzed (e.g., relative to an entity's keywords). As another example, a set of competitors may be referenced via the data store 214 (e.g., competitors previously stored in an association with an entity). As another example, a set of competitors may be identified by the competitor keyword identifier 222 or another component. For instance, a web search may be performed to identify competitors of an entity. As another example, AI, such as an LLM, may be used to identify competitors of an entity.

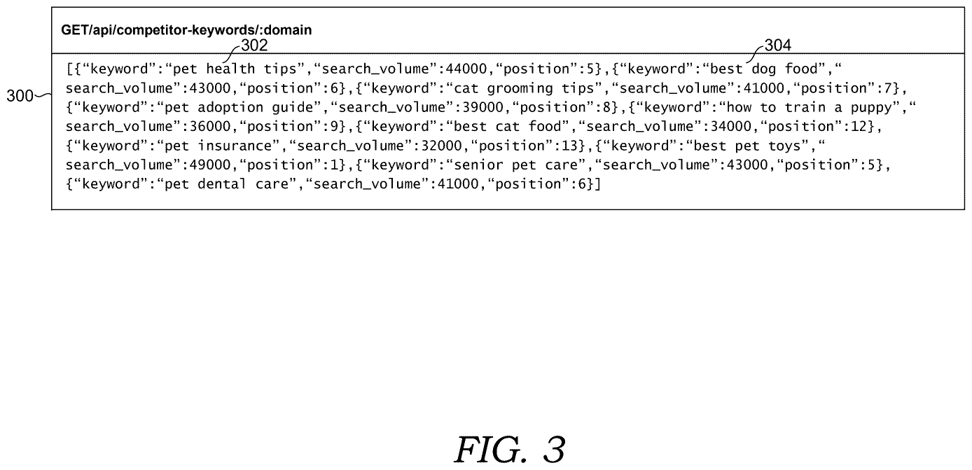

As described, the competitor keyword identifier 222 may identify competitor keywords in association with competitors. In some cases, competitor keywords are identified using various tools and/or APIs. One example for identifying competitor keywords includes the use of Ahrefs APIs. Ahrefs, or other tools, can be used to identify competitor keywords, such as keywords that other websites are ranking for. To identify competitor keywords using Ahrefs API, or other similar tool, the API may be used to retrieve various data. One endpoint in the Ahrefs API, which may be used to obtain competitor keywords, is/api/competitor-keywords/:domain endpoint. By way of example only, and with reference to FIG. 3, FIG. 3 provides an example of a set of competitor keywords 300. In this example, a particular domain for which keywords are desired may be provided. In this example, various keywords are returned for the “domain,” such as keyword 302 “pet health tips,” keyword 304 “best dog food,” and so on.

In operation, to obtain competitor keywords, an API endpoint enables fetching a list of keywords that a competitor's website is ranking for in search engines. To do so, the competitor's domain name may be provided to identify which website to analyze. A request may be sent to the endpoint, and Ahrefs returns a list of keywords and, in some cases, various other details, such as a search volume for each keyword (e.g., an estimate of how many searches a keyword receives per month), a ranking position of the competitor of each keyword (e.g., in the search engine results), an estimated traffic a competitor is receiving for keywords, and/or the like.

In accordance with identifying keywords associated with competitors, in some embodiments, the competitive keyword identifier 220 may filter the competitor keywords to reduce the set of competitor keywords to keywords that are more relevant to the entity. Competitor keyword filtering may be performed in any number of ways to filter keywords. As one example, brand-specific competitor keywords may be removed from the initial set of identified competitor keywords. For example, keywords specific to a brand of a competitor may be identified and removed (e.g., keywords including specific brand names). In this way, a brand-name filter may be applied to exclude or remove keywords containing a specified brand name(s).

As another example, competitor keywords having a difficulty rating greater than a threshold may be removed. A difficult rating, also referred to as keyword difficult or SEO difficulty, generally refers to a metric used to indicate how hard it would be to rank for a particular keyword. Such a rating may be based on various factors, such as the number of high-authority websites already ranking for the keyword, the quality and quantity of backlinks the top-ranking pages have, the content quality and relevance for that keyword, etc. The difficulty rating may be provided on a scale from 0 to 100, where 0 represents that the keyword is very easy to rank for and 100 represents the keyword is very difficult to rank for. In one example, competitor keywords having a difficulty rating greater than a threshold value, such as 50, may be removed. By removing keywords associated with a higher difficulty rating, competitor keywords that remain for further analysis are generally more achievable keywords that are easier to rank for. In some cases, a difficulty ranking may be obtained using Ahrefs, such as using the Ahrefs Keyword Explorer tool or Ahrefs API (e.g., in association with obtaining competitor keywords as described above).

In other cases, competitor keywords may be filtered based on relevance to the entity. Such a filtering may be performed based on a relevance analysis or score. For example, a comparison of the competitor keyword may be compared to data associated with the entity (e.g., brand data) to identify if the competitor keyword is relevant to the entity. For competitor keywords not identified as relevant to the entity, such keywords may be removed or filtered from the set of competitor keywords.

As described, the competitor keywords, or the filtered set of competitor key words, may be used to identify a set of candidate performant keywords. In this way, the comparative analyzer 224 may analyze a set of competitor keywords (e.g., filtered competitor keywords) to select or identify candidate performant keywords for an entity. To perform a comparative analysis, keyword performance data may be obtained for the entity and the set of competitor keywords being analyzed. Keyword performance data may refer to any data indicating performance of the keyword. In embodiments, keyword performance data includes performance statistics associated with the keyword. Performance statistics may include, for example, ranking, click through rate (CTR), etc. As one example, the position rankings associated with particular domains may be retrieved for the collected unique competitor keywords. A ranking, or position ranking, generally refers to a position or order at which an entity, such as a webpage or search result, appears in a search engine results page for a specific keyword or query.

In some cases, keyword performance data may be obtained in association with obtaining the competitor keywords and/or difficulty rating (e.g., using Ahref API or Ahrefs Keyword Explorer tool). That is, in accordance with obtaining competitor keywords and/or difficulty ratings for such keywords, for example, using an API or other tool, keyword performance data may additionally be obtained. Additionally or alternatively, keyword performance data may be obtained separate from obtaining the competitor keywords and difficult rating data. For example, a function or API call in a programming interface (e.g., Ahrefs API or other tool) may be used to retrieve ranking data for a given domain(s) across a list of keywords, such as competitor keywords, or a portion thereof (e.g., filtered competitor keywords). In one embodiment, getSiteRankingForKeywords (domain, uniqueCompetitorKeywords) may be used to retrieve the rankings of the specified domain for the collected unique competitor keywords. The domain refers to the website being analyzed, and the uniqueCompetitorKeywords includes the list of keywords that the competitors are ranking for (e.g., as identified via the competitor keyword identifier 222). The function may then return data that provides rankings for each of provided competitor keywords. In some cases, such a function or call may be used for each specific domain, such as the entity or a competitor. In other cases, a function or call may be used for a set of domains, including the entity and a set of competitors. Using such a function or API call is only provided as an example, and alterative tools may be used. For instance, a Site Explorer or Rank Tracker tool in Ahrefs may be used to obtain the rankings of a domain(s) for a set of keywords.

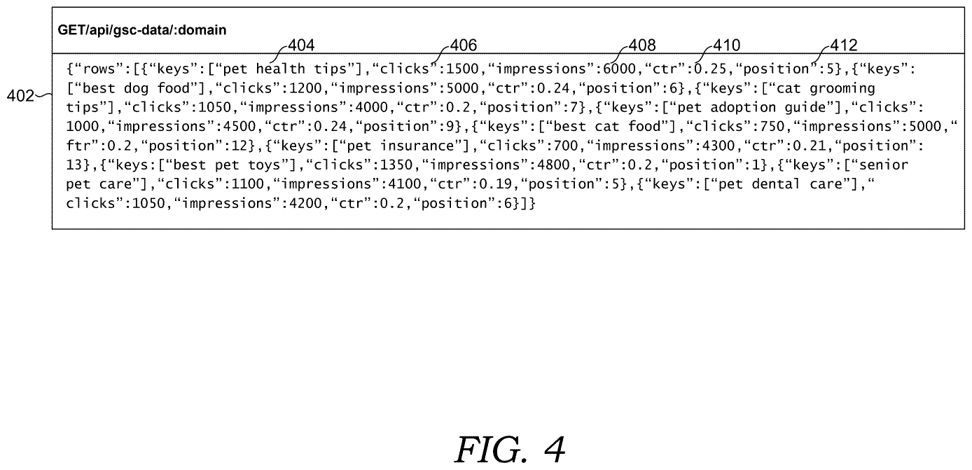

In addition to ranking performance data, other types of keyword performance data may also be obtained. For example, click through rates, clicks, impressions, etc. may also be obtained. Such keyword performance data may be obtained in any number of ways. As one example, Google Search Console and/or Ahrefs may be used to obtain such keyword performance data. For example, Google Search Console may be used to navigate to data related to a performance to view impressions, clicks, and click through rates. Impressions generally refers to the number of times a website's pages appear in search results for a specific query. Clicks generally refer to the number of times users clicked on a website's link from the search results. Click-through rate (CTR) generally refers to the percentage of individuals that clicked on a website after seeing it in the search results. Such metrics can be viewed for individual keywords, which may provide a list of all queries (e.g., keywords) that led to impressions and clicks for a website. By way of example only, and with reference to FIG. 4, FIG. 4 provides example data 402 that may be obtained using an API endpoint to obtain mock or simulated Google Search Console data for a given domain (e.g., ‘/api/gsc-data/:domain’). In this example data, for a particular competitor and the keyword 404 of “pet health tips,” 1500 clicks 406, 6000 impressions 408, 0.25 click-through rate 410, and a 5 ranking position 412 is provided. Such performance data is provided for various keywords.

As another example, Ahrefs provides a keyword research tool(s) that provides insights into how a keyword might perform. For instance, a Keyword Explorer tool may provide an estimated traffic number based on the current rankings for a keyword. Ahrefs may also provide an estimated click-through rate for each keyword and search volume. Other tools may additionally or alternatively be used to identify or obtain such keyword performance data.

In accordance with obtaining keyword performance data, such as ranking data for the entity and competitors in association with a set of keywords, keyword performance data may then be used to identify a set of candidate performant keywords. In embodiments, the keyword performance data may be analyzed to identify a keyword gap between keyword rankings associated with the competitor keywords and the entity keywords. They keyword gaps or differences may then be used to identify a set of candidate performant keywords. That is, keywords resulting in effective performance for a competitor, but less effective or missing for an entity may be identified as candidate performant keywords. In this way, a comparative analysis of performance data (e.g., rankings) associated with keywords of competitors may be compared to keyword performance data of a particular entity. Such a comparative analysis may identify where ranking or positioning of keywords is relative to a ranking(s) of a competitor(s) and use such a comparative analysis to identify keywords for which an entity may perform better.

In performing a comparative analysis, a keyword gap object may be generated. A keyword gap object generally refers to a data structure to facilitate analysis of the difference between two or more domains or websites, particularly in association with the keywords for which they are ranking. As described, a keyword gap may represent missing keywords that one entity ranks for but another entity does not rank for or represent opportunities to improve ranking using the keyword (e.g., one entity ranks higher than the target entity). Various tools may be used to generate a keyword gap object, such as, for example, Ahrefs, SEMrush, Moz, etc. In embodiments, keyword gap objects may be generated for any number of entities (e.g., websites), for example, to compare any number of entities. For example, assume a target entity is being analyzed in association with five competitors. In such a case, the keyword gap object may include rankings for keywords in association with the target entity and each competitor of the target entity.

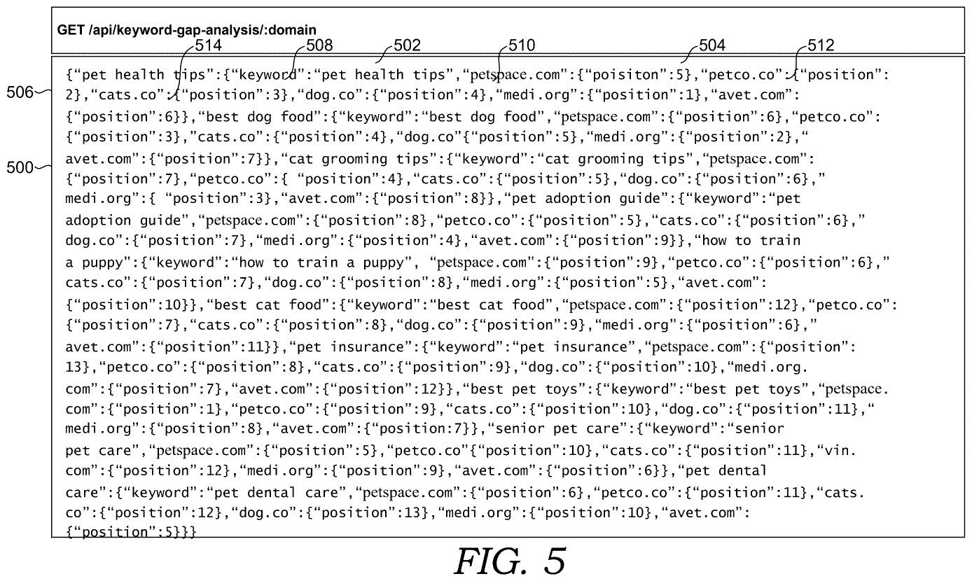

By way of example only, FIG. 5 provides an example of performance data, such as keyword gap object or analysis using an API ‘/api/keyword-gap-analysis/:domain.’ In the example data 500 of FIG. 5, for a set of competitors and a set of keywords, ranking position may be provided. For instance, for a keyword 502 of “pet health tips,” petspace. com is ranked 5 504, petco.co is ranked 2 506, cats. co is ranked 3 508, dog.co is ranked 4 510, medi.org is ranked 1 512, avet.com is ranked 6 514. Such ranking performance data is provided for various keywords and various entities (e.g., a target entity website and competitor websites). In examples, a keyword gap analysis may be returned as a JSON response containing the constructed keyword gap object that provides insights into keyword ranking disparity between a target entity or domain and its competitors.

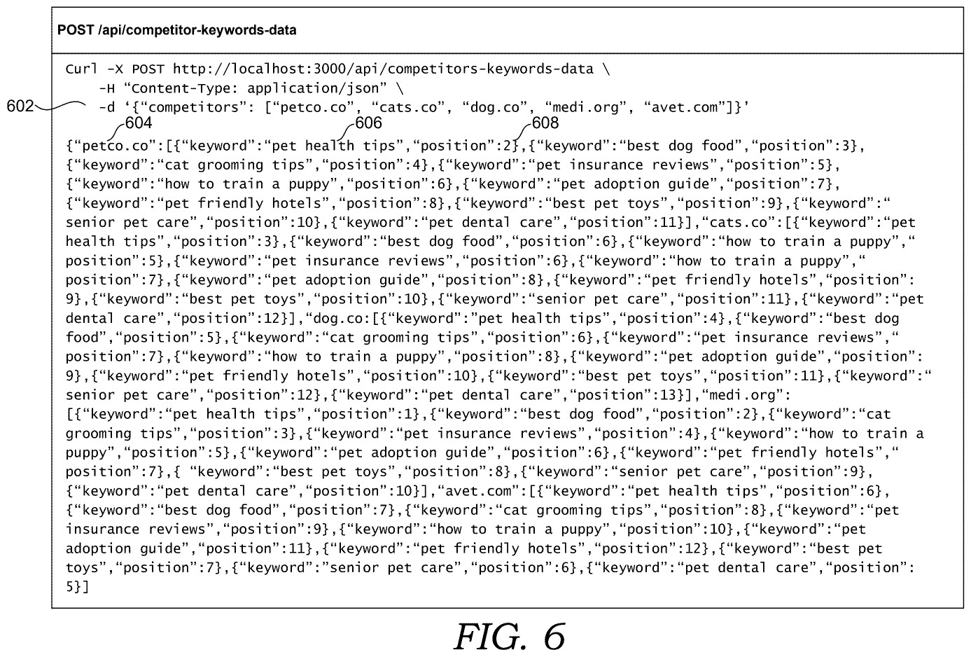

FIG. 6 provides another example of a set of keyword performance data 600. In this example, an API endpoint may be used to obtain keywords, search volume, and position of competitors, via ‘/api/competitors-keywords-data.’ In this example, the set of competitors 602 is provided. For each competitor, a set of keywords and positions are provided. For instance, for domain petcoach.com 604 and the keyword “pet health tips” 606, the position 2 608 is provided.

As described, using the performance data, the comparative analyzer 224 can identify a set of candidate performant keywords. In some cases, keywords performing well with competitors but not performing well with the target entity or not used by the target entity may be identified. As such, in some cases, keywords for which the target entity is ranked below a threshold value (e.g., a position of 6) and a competitor(s) is ranked higher may be identified. In this way, candidate performant keywords may be identified for keywords a target entity is not effectively using (e.g., associated with a low ranking). Keyword gaps may be identified in cases in which a target entity does not have content including a keyword used by a competitor or the target entity is positioned or ranked lower than a competitor.

In some cases, the comparative analyzer 224 may provide a set of candidate performant keywords for display to a user. Any number of candidate performant keywords may be selected for presenting via a display. For example, a predetermined number of candidate performant keywords may be selected, such as a top 10 impactful keywords. As another example, candidate performant keywords exceeding a threshold value (e.g., score) may be selected to display. In embodiments, the most impactful or potentially performant keywords may be determined in any number of ways. For instance, the candidate performant keywords may be ranked based on distance or discrepancy in ranking of a competitor in comparison to a target entity. In this regard, those with the largest distance or gap between rankings may be ranked higher than those with a smaller distance between rankings. As another example, candidate performant keywords associated with higher rankings may be ranked higher. As yet another example, candidate performant keywords missing from a target entity may be ranked higher than candidate performant keywords in which the target entity ranks lower than a competitor. As yet another example, candidate performant keywords more relevant to a target entity may be ranked higher or prioritized over less relevant candidate performant keywords. Accordingly, candidate performant keywords may be ranked or prioritized in any number of ways and/or combinations thereof.

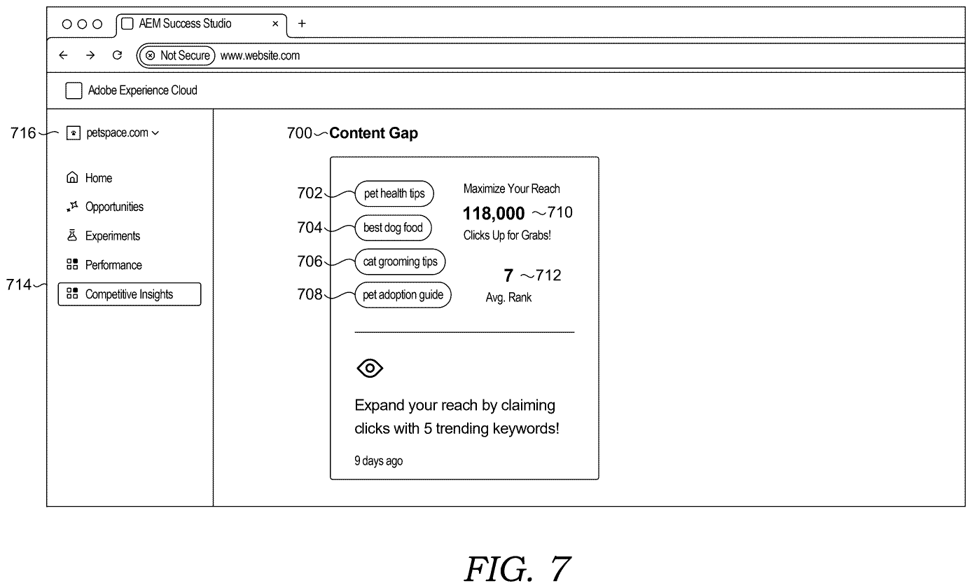

One example for illustrating candidate performant keywords is provided in FIG. 7. As shown in FIG. 7, candidate performant keywords 702, 704, 706, and 708 may be provided as candidate performant keywords 700 representing keyword gaps between the target entity and competitors. In this example, keyword gap insights may also be presented. Keyword gap insights provide data or insights in association with use of an identified candidate performant keyword that represents a gap between a target entity and a competitor. As such, the keyword gap insights can provide an indication of the positive impact that may result if the candidate performant keyword(s) is used by the target entity. In this example, keyword gap insight 710 provides an indication of a number of clicks that can be increased using the presented candidate performant keywords 702-708, and keyword gap insight 712 provides an indication of an average rank of the candidate performant keywords 702-708. Such a presentation of candidate performant keywords may be initiated in any number of ways. As one example, a user may select to view “competitive insights” 714 in relation to a specific or selected website 716.

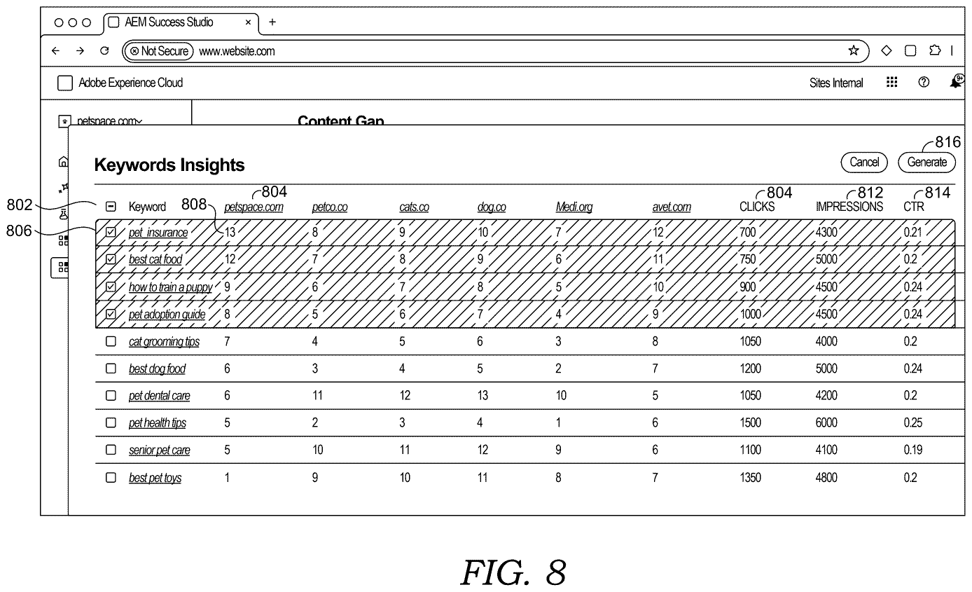

Another example for illustrating candidate performant keywords is provided in FIG. 8. FIG. 8 provides an example visual representation of data provided by API responses associated with FIG. 3 and FIG. 6. In this example, the set of keywords 802 are positioned in the first column of the table, and the set of entities, or domains, are positioned in the first row of the table. For each listed entity and keyword pair, the corresponding ranking is provided. For example, for the entity “petspace.com” 804 and the keyword “pet insurance” 806, the ranking of the keyword is “13” 808. Such a table provides details to the user such that the user may understand the candidate performant keywords identified. For example, assume “petspace.com” 804 is the target entity and the other presented entities are competitors. As shown, for the use of the keyword “pet insurance” 808, the ranking is “13.” In comparison to the keyword rankings associated with the competitors, the “13” ranking is lower and, as such, may be an opportunity for improving performance in association with “petspace.com” 804. Other keyword performance data may be provided, such as clicks 810, impressions 812, and CTR 814. Using this data, a user may select keywords of interest (e.g., via checkboxes associated with the keywords) and, thereafter, select to “generate” 816 to generate content data using the selected keywords. In this way, the selected keywords are target keywords used to generate content data. Such a presentation of candidate performant keywords and corresponding data may be initiated in any number of ways. As one example, a user may select a candidate performant keyword presented in FIG. 7 to view such data.

Identifying candidate performant keywords may occur at any time. In some cases, candidate performant keyword identification may occur based on a user selection. In other cases, candidate performant keyword identification may occur based on a lapse of a time duration or occurrence of an event (e.g., the target entity ranking or performance falls below a threshold).

The content data generator 230 is generally configured to generate content data using one or more of the identified candidate performant keywords. Content data generally refers to any data associated with content. In this regard, content data may include text content, meta tags, URL, header tags, images, schema markup, internal linking, etc. Text content refers to text generally includes keywords. In implementation, the text content may be strategically created to incorporate specific keywords that users are likely to search for in search engine. In addition to text content including keywords, the text content typically provides value to a reader, for example, by answering their questions or providing information associated with a search. In addition to text content, keywords are oftentimes incorporated into other aspects or components of a domain or website, such as meta tags, URLs, header tags, images, schema markups, internal linkings, etc. Meta tags generally refer to HTML elements that provide metadata about a webpage or website. Meta tags generally facilitate search engines and browsers understanding of the content of the page, but are not directly visible to website visitors. Meta tags may be in various forms, such as a meta title and a meta description. A meta title tag is used to define the title of the webpage that appears in search engine results page and in the browser tab. Meta description tag generally provides a summary of the content of the page. Meta tags may use keyword in an effort to provide search engines with additional information associated with the content of a webpage. A URL is the web address used to access a specific resource, such as a webpage, image, or file, on the internet. Keywords may be included in a URL to enable search engines and users to understand the content of a webpage. A header tag generally refers to an HTML tag that is used to define headings and subheadings within the content of a webpage. Header tags may be used to organize the content and make it easier to read and understand for users and/or search engines. Header tags may include keywords to signal to search engines the primary focus of the webpage or specific sections therein. As a search engine considers header tags a significant ranking factor, including relevant keywords in the headers can improve the opportunity for a higher ranking. An image may be any image included in the content of a webpage or website. Generally, an image may be optimized using keywords to improve its discoverability by search engines and enhance the overall ranking of the webpage in which the image resides. Keywords may be used in association with images in a variety of manners, including within the file name of the image, alternative text used to describe an image that appears when the image cannot be displayed, an image title, an image caption, or the like. Schema markups, also referred to as structured data, generally refers to a form of code that can be added to a website to help search engines understand context of the content. Using keywords in schema markups may facilitate a search engine to understand the context of the content and, as such, improve visibility in search results. An internal linking generally refers to a linking of one page or portion of content within a website to another page on the same website. Such links may be embedded in the body content, navigation menus, footers, sidebars, etc. Keywords may be used in internal linking to help search engines understand the content and context of the linked pages. Using relevant keywords as anchor text signals to search engines what the page is about, which can improve the page's ranking for those specific keywords.

Content data generation may include generating new content or modifying existing content, such as text content, metatags, URLs, header tags, images, schema markups, internal linkings, etc. For example, in some cases, a new website may be created, including various aspects of content data. In other cases, an existing website, or a portion thereof, may be modified or updated to increase performance of the website. For example, a paragraph of text may be revised to incorporate one or more candidate performant keywords. Further, any number of content variations may be generated by the content data generator 222. For example, in some cases, multiple websites, or portions thereof, may be created to provide variations of content.

In accordance with embodiments described herein, the content data generator 222 generally generates or creates content using one or more of the candidate performant keywords. In this way, content is created in a manner that is intended to leverage keyword gaps (e.g., between an entity and its competitor(s)) to increase performance of content offered or provided by an entity. As described herein, the candidate performant keywords selected for use in generation content data may be referred to as target keywords. In some cases, the set of candidate performant keywords identified by candidate performant keyword identifier 220 may be used as target keywords to generate content. In other cases, a subset of candidate performant keywords identified by candidate performant keyword identifier 220 may be used as target keywords to generate content. A subset of candidate performant keywords used as target keywords may be selected or identified in any number of ways (e.g., based on a user selection, automatically determined based on a score, etc.). For example, candidate performant keywords identified via candidate performant keyword identifier 220 may be presented to a user, as shown in FIGS. 7 and 8. In such a case, a user may select one or more of the presented keywords for use in generating content. In this way, the content data generator 222 may use the selected keywords as target keywords to generate content.

In some cases, content data generation may be automatically performed. For example, in accordance with identifying a set of candidate performant keywords, such keywords may be automatically used to generate content data. In other cases, content data generation may be initiated based on a user selection. For example, in accordance with selecting one or more of the presented candidate performant keywords for use in generating content, the user may select to “generate content” (e.g., as illustrated at 816 in FIG. 8).

Content data may be generated in any of a number of ways. In one embodiment, AI technology, such as generative AI or an LLM, may be accessed or used to generate content data. For example, an indication of a target keyword(s) may be included in a prompt for use in generating content data. In some cases, the prompt may include various target keywords (e.g., selected from a set of candidate performant keywords) for use by the LLM to create content data, such as text content, in association with an entity (e.g., a website). Accordingly, the content data manager 230 may include a prompt generator 232 and a content generator 234.

The prompt generator 232 is generally configured to generate a content generation prompt that may be used to initiate generation of content data, such as text content, images, etc. A content generation prompt generally refers to an input, such as an input text and/or graphic, that can be provided to a content generator 234, such as an LLM, LVM, and/or MLLM, to generate an output in the form of content data. In embodiments, the content generation prompt can include content, such as text and/or images, to influence an AI model (e.g., an LLM) to generate content data having a desired keyword(s). A prompt typically includes text given to an AI model to be completed. In this regard, a prompt generally includes instructions and, in some cases, data to use in performing the analysis. Additionally or alternatively, the content generation prompt may include images, or other non-text data, to influence an AI model, such as an LVM and/or MLLM, to generate an output having desired content and structure.

In accordance with embodiments described herein, a content generation prompt may include or reference various types of data. By way of example only, a content generation prompt may include, among other things, an instruction or request and a set of target keywords to be used in content generation. An instruction generally refers to a request for performing generation of content data, for example, in accordance with one or more target keywords. For instance, a content generation prompt may include a request to generate content data, or a particular type of content data, in accordance with one or more target keywords.

Further, in embodiments, an indication of a set of target keywords may be provided in the content generation prompt to use in generating content data. Any number of target keywords may be included in a prompt. As described, target keywords may include a set of candidate performant keywords identified via the candidate performant keyword identifier 220 and/or selected from a user (e.g., based on presentation of a set of candidate performant keywords identified via the candidate performant keyword identifier 220).

In some cases, a separate content generation prompt may be generated for different types of content data (e.g., text content, meta tags, URLs, images, etc.). In such a case, the content generation prompt includes an indication of a particular type(s) of content data to generate. Accordingly, for each content generation prompt, the instruction or request may pertain to the particular type(s) of content data to generate. In other cases, a single content generation prompt may be used to initiate generation associated with various types of content data.

Further, in some cases, a separate content generation prompt may be generated to initiate generation of each content data variation or version. For instance, a first content generation prompt may be generated to initiate generation of a first content data variation, and a second content generation prompt may be generated to initiate generation of a second content data variation.

In embodiments, a content generation prompt may include or reference an existing content associated with a target entity to use for generating content data. For example, an existing website, or component thereof, associated with a target entity may be included or referenced for use in generating content data (e.g., modifying the existing website or creating a new website, or a component there, such as a title).

As can be appreciated, in some embodiments, the content generation prompt may include additional or alternative data, such as output attributes or additional context. Output attributes generally indicate desired aspects associated with an output, such as content data. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a target language for generating the output. For example, the data may be provided in one language, and an output attribute may indicate to generate the output in another language. Any other instructions indicating a desired output are contemplated within embodiments of the present technology.

Additional context may include any additional information that provides context to the request. Additional context may include a day/time, an indication of a brand, keyword performance data, etc. Any additional context may be provided to indicate or describe the existing content or the content desired to be generated.

In some embodiments, the prompt generator 232 may be configured to select particular data, such as existing content data, to include in the prompt. As one example, existing content data, including existing content or keywords, may be selected to be under a maximum number of tokens required by a content generator, such as an LLM. For example, assume an LLM includes a 3,000-token limit. In such a case, text data totaling less than the 3,000-token limit may be selected. In this regard, prompts may have a size limit, thereby limiting the amount of data included in the prompt. As such, in some cases, using all content or data (e.g., associated with an existing website) may not be possible to be used as a prompt to an LLM due to size limitations of an LLM. Hence, it is necessary to select an optimal set of existing content data for feeding to the LLM for obtaining generated content data. Although generally described as using tokens (e.g., pieces of words, individual sets of letters within words, spaces between words, and/or other natural language symbols or characters) for input size, as can be appreciated, other input sizes may be used and may not necessarily be based on token sequence length, but other data size parameters, such as bytes, number of words, etc.

Accordingly, in embodiments, the prompt generator 232 may be configured to select data, such as existing content data, to include in a prompt to generate content data in association with a target entity. To identify data, such as existing content data, to include, any aspect or score may be used. For example, in some cases, an existing content score may be generated and used to select existing content data. The score may represent an importance or value associated with the existing content. Such a score may indicate an extent or measure of some aspect for assessing content to include in the content generation prompt. For example, a score may indicate relevance to informativeness, diversity, and/or the like. In other cases, existing content data related to a selected or particular type of content data may be selected.

The prompt generator 232 may format the prompt in a particular form or data structure. One example of a data structure for a content generation prompt is as follows:
{Instruction to generate content data
{Types of content data to generate
{Existing content(s) to evaluate
{Set of target keywords for use in creating content data
   {Target Keyword 1
      . . .
   {Target Keyword 2

As described, any number of content generation prompts may be generated. As one example, different content generation prompts may be generated for different types of content data to generate (e.g., a first content generation prompt for a first type of content generation and a second content generation prompt for a second type of content generation). As another example, different content generation prompts may be generated for different content variations (e.g., a first content generation prompt for a first content variation to be generated, and a second content generation prompt for a second content variation). As yet another example, different content generation prompts may be generated for different target keywords or sets of target keywords (e.g., a first content generation prompt for a first set of target keywords, and a second content generation prompt for a second set of target keywords). Further, content generation prompts may be generated for various combinations.

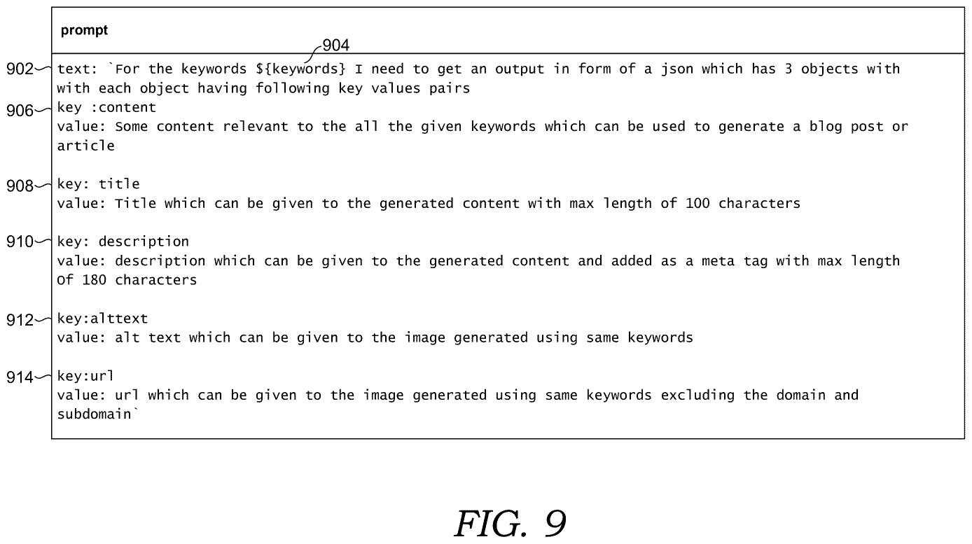

FIG. 9 provides one example of a content generation prompt that may be generated to use in performing content data generation. In this example, an instruction 902 is provided to request generation of three content variations using keywords 904. Each generated content variation is requested to include content data components of a text content 906, title 908, a description 910, image text 912, and a URL 914. For each content data component, the prompt includes desired values, as illustrated. For instance, for the text content 906, content relevant to all the target keywords which can be used to generate a blog post or article is specified.

The content generator 234 is generally configured to generate content data. In this regard, the content generator 234 uses target keywords to generate content data, such as text content, image content, URLs, internal linkings, etc. As such, the content generator 234 facilitates generation of effective content. In embodiments, the content generator 234 takes, as input, a content generation prompt generated by the prompt generator 232. Based on the content generation prompt, the content generator 234 can generate content data, for example, including one or more target keywords included or indicated in the prompt. For instance, assume a content generation prompt includes a set of target keywords identified via candidate performant keyword identifier 220. In such a case, the content generator 234 generates content that incorporates at least a portion of the target keywords included in the content generation prompt.

The content generator 234 may be or include any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the content generator 234 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the content generator 234 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the content generator 234, in the form of an LLM, LVM, and/or MLLM, can obtain a content generation prompt and, using such information in the content generation prompt, generate a set of content data in association with an entity (e.g., a website). In some embodiments, the content generator(s) takes on the form of an LLM, LVM, and/or MLLM, but various other AI models can additionally or alternatively be used.

Use of LLM, LVM, and/or MLLM may depend on the format of content to be evaluated. As one example, content generation prompts including only text may be processed via an LLM, and content generation prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. Accordingly, although the content generator 234 is illustrated as a single component, any number of components may be used to generate content.

As described herein, the content data is generated in a way that includes use of target keywords in an effort to generate more performant content for an entity. In this way, content may be generated that improves outcomes associated with the content, such as an improvement in ranking position of the content (e.g., in association with the keywords), an increase in click through rates, etc.

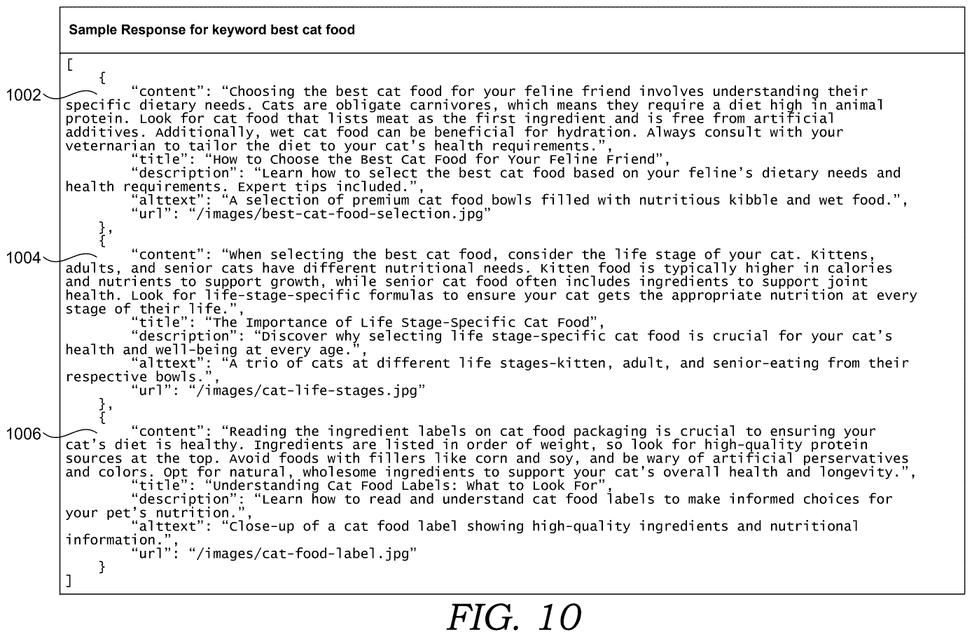

One example of generated content data is provided in FIG. 10. In accordance with the input prompt illustrated in FIG. 9, the response generated may include content variation 1002, content variation 1004, and content variation 1006. Each content variation includes a text content, a title, a description, an image content, and a URL. Advantageously, such content includes one or more target keywords provided in the prompt in an effort to generate a more effective or performant set of content for an entity. For instance, the content is generated in a manner that intends to fill an identified keyword gap between the existing content associated with the entity and keywords used by competitors that resulted in an improved ranking.

In some embodiments, content data may be generated in an iterative manner. For example, upon generating text content, content data in the form of meta tags may be generated such that they are generated in association with the generated text content. In this regard, types of content data may rely on or be more suitably generated based on an update to other types of content data. As such, in some cases, particular types of content data may be generated for other types of content data.

In embodiments, the content generator 234 generates content in accordance with a brand(s) associated with the entity. In this way, the generated content complies with desired brand guidelines associated with an entity. For example, content generated may be in aesthetic form, layout, tone, etc. that complies with the corresponding brand guidelines. In some cases, the AI technology may be trained or refined to generate content in accordance with brand guidelines. In other cases, a generated prompt may include, reference, or indicate a set brand guidelines to use in generating content. In yet other cases, brand guidelines may be incorporated to modify generated content. In this way, upon generating content, the brand guidelines may be taken into account to modify or update the content in accordance with any brand guideline not met.

Although the content generator 234 is illustrated in association with the content optimization manager 212, in some cases, the content generator 234, or AI technology, may be separate or remove from the content optimization manager 212. In this way, a content generation prompt may be generated and provided to an external or remote AI technology that facilitates generation of content data. In such a case, the content data generated may be returned to the content optimization manager 212 in the form of a response.

The content data provider 240 is generally configured to manage providing the content data. In this regard, content data generated or obtained via the content data manager 230 may be managed and/or transmitted by the content data provider 240. In some cases, in accordance with the content data manager 230 identifying content data, the content data may be stored, for example, in data store 214. Additionally or alternatively, content data, such as content data 250, may be provided to a user device or user for viewing, such as via user device 110 of FIG. 1, or another component for viewing or performing further analysis.

In some cases, content data may be presented to a user for a user to select or confirm whether to incorporate the generated content. For example, in some cases, generated content data may be presented to a user via a user device. The user may view the generated content data and select or confirm to use the generated content data in association with the entity (e.g., website). Content data may be presented, via a user interface, in any number of ways. As one example, content data may be presented in association with a set of target keywords used to generate content, an existing content, etc. In this way, a user may select to view generated content data and/or integrated content. As another example, multiple variations of generated content data may be presented to a user and, thereafter, the user may select a preferred set of content data to use in association with the entity.

In some embodiments, the content data provider 240 manages or facilitates incorporating the content data in association with an entity (e.g., a website). In some cases, the content data to incorporate may be automatically integrated upon being generated or obtained. In other cases, the content data to incorporate may be based on a selection or confirmation of particular content data to incorporate in association with an entity. Various types of content may be integrated and such integration may be performed in any of a number of ways. As one example, assume text content is generated. In such a case, the content data provider 240 may facilitate injecting the generated content into an existing section of a website. By way of example only, a generated content related to “A Comprehensive Guide to the Best Cat Food in 2023,” may be injected into the existing “Pet Health” section of petspace. com. For instance, to do so, sitemap. xml may be provided to AI technology, such as a generative AI model, to identify a most suitable section in which the article would be best suited. Continuing with this example, the title tag of the “Pet Health” section may be updated to “A Comprehensive Guide to the Best Cat Food |Pet health tips-petspace,” and the meta description may be updated to “Discover the top-rated cat food nutritional tips to keep your feline health. Expert advice on choosing the best cat food brands and ingredients.” Such a title and description may be generated using AI technology, as described herein, and used to update the previously existing title and description. The URL of the article page may be updated to “https://www.petspace.com/best-cat-food-guide” to ensure the new URL reflects the content and includes target keywords. Header tags and image optimization may also be performed. For instance, the H1 tag may be modified to “<h1>Comprehensive Guide to Best Cat Food</h1>.” H2 and H3 tags may be used for subheadings such as “Choosing the Right Cat Food Brand” and “Nutritional Benefits of Quality Ingredients.” Images generated using AI technology may also be added to the article. Further, image alternative text may be updated to improve an accessibility score by including keywords such as “best cat food” and “nutritional benefits of cat food” in association with an image(s). Schema markup updates may also be performed by adding JSON-LD structured data for an article, for instance, by specifying it as a “blog posting” with details on cat food reviews, nutritional benefits, and brands mentioned. To integrate internal linking, a link to a comprehensive guide from related articles and sections within petspace. com may be provided within petspace. com using anchor text, such as “best cat food guide” or “nutrition tips for cats.” In some embodiments, such integration of content data in association with a website may be performed by another component. For example, the content data provider 240 may provide the content data to another component that manages a website for content data to be incorporated into the website.

In accordance with integrating the newly generated content data in association with a target entity (e.g., website), the updated entity (e.g., a website with the generated content data incorporated therein) may be stored and/or provided to search users. For instance, as a user searches for a topic or content, a website that incorporates the new content data may be presented to the user or presented as a search result to the user. By way of example only, assume a search user performs a search for a particular aspect or item. In identifying search results, a search engine may use the content data incorporated into the website to identify a search result ranking and present representations of the search results. Advantageously, as the website includes identified target keywords, the website performance, such as a search result ranking, should be improved. Accordingly, the search user may readily view the website search result (e.g., associated with a higher ranking) and, in response, be presented with content that reflects the generated content data, or a portion thereof. In this way, in addition to improving a search result ranking for the website, the website includes content that may be more suitable or desired by the search user.

### Exemplary Implementations for Facilitating Content Generation Using Target Keywords for Performance Optimization

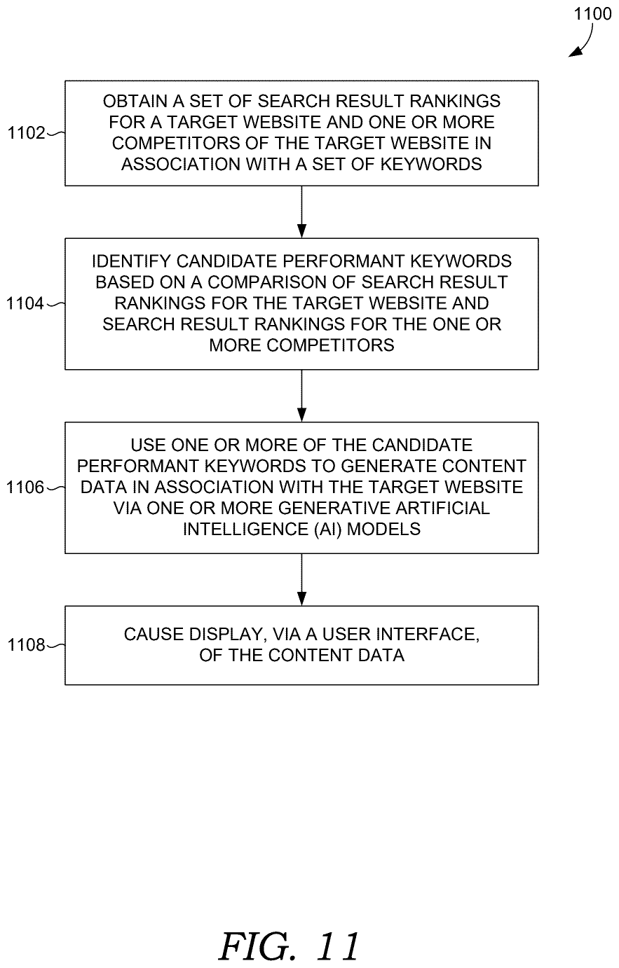

As described, various implementations can be used in accordance with embodiments described herein. FIGS. 11-13 provide methods of facilitating content generation using target keywords for performance optimization, in accordance with embodiments described herein. The methods 1100, 1200, and 1300 can be performed by a computer device, such as device 1400 described below. The flow diagrams represented in FIGS. 11-13 are intended to be exemplary in nature and not limiting.

Turning initially to method 1100 of FIG. 11, method 1100 is directed to one implementation of facilitating generation of content data for performance optimization, in accordance with embodiments described herein. Initially, at block 1102, a set of search result rankings for a target website and one or more competitors of the target website in association with a set of keywords is obtained. Search result rankings may be obtained in any of a number of ways. As one example, a set of competitors of the target website may be identified. Thereafter, competitor keywords associated with the competitors are identified. In some cases, the competitor keywords can be filtered, for example, based on relevance, brand, etc.

At block 1104, candidate performant keywords are identified based on a comparison of search result rankings for the target website and search result rankings for the one or more competitors. In some embodiments, a candidate performant keyword is identified based on a search result ranking for the target website being lower than one or more search result rankings associated with competitors. For instance, assume a target website ranking in association with a keyword is “15,” and a set of competitors correspond with rankings of “1,” “3,” and “6” in association with the keyword. In such a case, the keyword can be identified as a candidate performant keyword. In additional or alternative embodiments, a candidate performant keyword is identified based on a competitor using a keyword that is not used by the target website.

At block 1106, one or more of the candidate performant keywords are used to generate content data in association with the target website via one or more generative artificial intelligence (AI) models. Various types and combinations of content data may be generated, such as, for example, text content, image content, a URL, a meta tag, a header tag, a schema markup, an internal linking, etc. Such content data may be generated in any number of ways. In some embodiments, a prompt is generated to provide as input to one or more generative AI models. Such a prompt may include an indication of candidate performant keywords, an instruction to generate content data, an indication of a particular type of content data, etc.

At block 1108, the content data is displayed. In some cases, the content data is presented via a user interface to a user to select or confirm integration of the content data with the target website. Further, any number of versions or variations of generated content data may be presented (e.g., as candidate options of content data). Based on a selection or confirmation of content data, the content data may be integrated or incorporated into the target website or used to generate a new target website. In other cases, the content data may be automatically integrated or incorporated into a target website or used to generate a new website, or portion thereof. Using the updated or new website, the content, including the identified keywords, may be presented in accordance with a search user searching for information (e.g., via presentation in search results or a user selection of a search result).

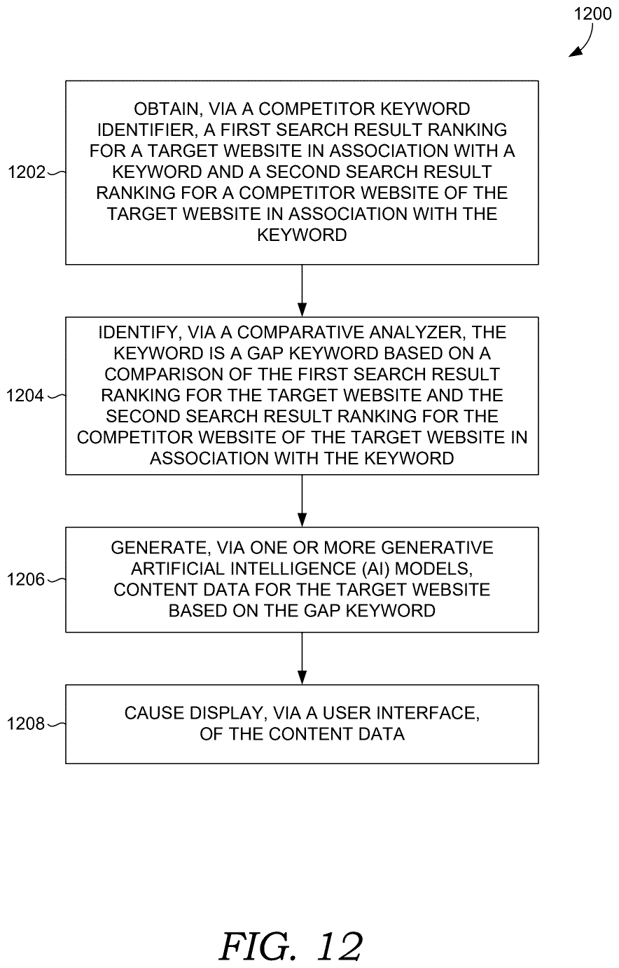

Turning to FIG. 12, method 1200 of FIG. 12 is directed to another example implementation of facilitating generation of content data for performance optimization, in accordance with embodiments described herein. Initially, at block 1202, a first search result ranking for a target website in association with a keyword and a second search result ranking for a competitor website of the target website in association with the keyword are obtained via a competitor keyword identifier. Such search result rankings may be obtained using an API or other tool to identify such rankings in association with one or more keywords.

At block 1204, the keyword is identified, via a comparative analyzer, as a gap keyword based on a comparison of the first search result ranking for the target website and the second search result ranking for the competitor website of the target website in association with the keyword. In some cases, a keyword is identified as a gap keyword based on a search result ranking for a target website being lower than a search result ranking for a competitor website. In other cases, a keyword is identified as a gap keyword based on the keyword being used by a competitor website and not being used by the target website. In this way, the target website is missing or void of a keyword being used by a competitor. In some embodiments, the gap keyword may be presented via a user interface to present as an option for using to generate content. In this way, a user may view the keyword and select to use the gap keyword to generate content data.

At block 1206, content data for the target website is generated, via one or more generative AI models, based on the gap keyword. Generating content data for a target website may include generating a prompt that includes an indication of a gap keyword and an indication of a type of content data to generate. Such a prompt can then be provided as input to one or more generative AI models to generate the content data.

At block 1208, the content data is displayed via a user interface. In embodiments, the content data is included in the target website to increase or improve the performance of the target website, for example, in association with search result rankings, click-through rates, selections, etc. In some cases, the content data is included in the target website based on a user selection or confirmation to include the displayed content into the target website. In such a case, the content data may be added to the existing target website or used to replace existing content in the target website. For example, assume a new URL is proposed as content data for use in association with a target website. In such a case, the existing or prior URL is replaced with the new URL.

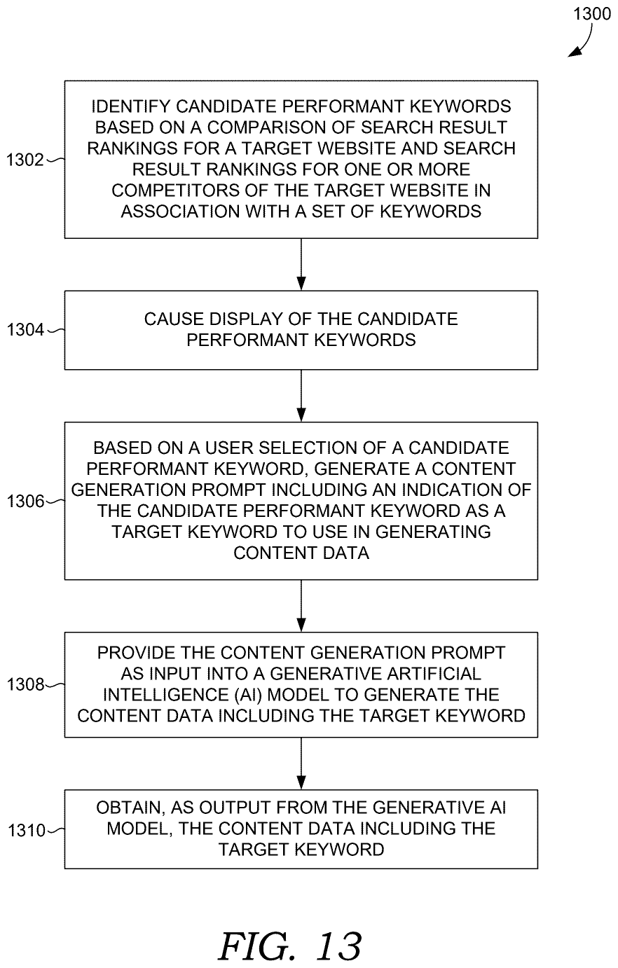

With reference now to FIG. 13, method 1300 of FIG. 13 is directed to another example implementation of facilitating generation of content data for performance optimization, in accordance with embodiments described herein. At block 1302, candidate performant keywords are identified based on a comparison of search result rankings for a target website and search result rankings for one or more competitors of the target website in association with a set of keywords. In embodiments, identifying candidate performant keywords includes identifying a first candidate performant keyword based on the target website not including a first keyword included within a competitor and identifying a second candidate performant keyword based on the target website having a lower search result ranking for a second keyword than at least one competitor.

At block 1304, the candidate performant keywords are displayed. The candidate performant keywords may be displayed in any number of ways. In embodiments, the candidate performant keywords are displayed in association with performance data.

At block 1306, a content generation prompt is generated based on a user selection of a candidate performant keyword, the content generation prompt including an indication of the candidate performant keyword as a target keyword to use in generation content data. At block 1308, the content generation prompt is provided as input into a generative AI model to generate the content data including the target keyword.

At block 1310, the content data, including the target keyword, output from the generative AI model is obtained. Such content data may be provided to the user device for presentation of the generated content data, including the target keyword, to the user. In some cases, a user may select or confirm to include the content data in the target website. In such cases, the target website is updated or modified to include such content data. The updated or modified target website can be published and used to execute subsequent searches. In this way, the updated target website is used or analyzed when a search engine provides search results for subsequent search requests.

### Overview of an Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 14 in particular, an exemplary operating environment for implementing aspects of the technology described herein is shown and designated generally as computing device 1400. Computing device 1400 is just one example of a suitable computing environment and is not intended to suggest any limitation as to the scope of use or functionality of the technology described herein, and nor should the computing device 1400 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 14, computing device 1400 includes a bus 1410 that directly or indirectly couples the following devices: memory 1412, one or more processors 1414, one or more presentation components 1416, input/output (I/O) ports 1418, I/O components 1420, an illustrative power supply 1422, and a radio(s) 1424. Bus 1410 represents what may be one or more buses (such as an address bus, data bus, or combination thereof). Although the various blocks of FIG. 14 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 14 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 14 and refer to “computer” or “computing device.”

Computing device 1400 typically includes a variety of computer-readable media. Computer-readable media can be any available media that can be accessed by computing device 1400 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1412 includes computer storage media in the form of volatile and/or non-volatile memory. The memory 1412 may be removable, non-removable, or a combination thereof. Exemplary memory includes solid-state memory, hard drives, and optical-disc drives. Computing device 1400 includes one or more processors 1414 that read data from various entities such as bus 1410, memory 1412, or I/O components 1420. Presentation component(s) 1416 present data indications to a user or other device. Exemplary presentation components 1416 include a display device, speaker, printing component, and vibrating component. I/O port(s) 1418 allow computing device 1400 to be logically coupled to other devices including I/O components 1420, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1414 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 1400. The computing device 1400 may be equipped with depth cameras, such as stereoscopic camera systems, infrared camera systems, RGB camera systems, and combinations of these, for gesture detection and recognition. Additionally, the computing device 1400 may be equipped with accelerometers or gyroscopes that enable detection of motion. The output of the accelerometers or gyroscopes may be provided to the display of the computing device 1400 to render immersive augmented reality or virtual reality.

A computing device may include radio(s) 1424. The radio 1424 transmits and receives radio communications. The computing device may be a wireless terminal adapted to receive communications and media over various wireless networks. Computing device 1400 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. One or more computer storage media having computer-executable instructions embodied thereon that, when executed by one or more processors, cause the one or more processors to perform a method, the method comprising:
obtaining a set of search result rankings for a target website and one or more competitors of the target website in association with a set of keywords;
identifying, via a comparative analyzer, candidate performant keywords based on a comparison of search result rankings for the target website and search result rankings for the one or more competitors;
using one or more of the candidate performant keywords to generate content data in association with the target website via one or more generative artificial intelligence (AI) models; and
causing display, via a user interface, of the content data.

2. The media of claim 1, wherein obtaining the set of search result rankings comprises:
identifying a set of competitors of the target website;
identifying competitor keywords associated with the set of competitors; and
filtering the competitor keywords to identify the set of keywords relevant to the target website.

3. The media of claim 1, wherein at least one candidate performant keyword is identified based on a search result ranking for the target website being lower than one or more search result rankings associated with the one or more competitors.

4. The media of claim 1, wherein at least one candidate performant keyword is identified based on a competitor using a keyword that is not used by the target website.

5. The media of claim 1, wherein the content data comprises one or more of text content, image content, a Uniform Resource Locator (URL), a meta tag, a header tag, a schema markup, an internal linking, or a combination thereof.

6. The media of claim 1, wherein using the one or more of the candidate performant keywords to generate content data comprises:
generating a prompt that includes the one or more of the candidate performant keywords; and
providing the prompt as input to the one or more generative AI models to obtain, as output, content data.

7. The media of claim 1 further comprising incorporating the content data into the target website.

8. The media of claim 1 further comprising:
causing display, via the user interface, of the candidate performant keywords; and
obtaining a user selection, via the user interface, of the one or more candidate performant keywords for use in generating content data.

9. A computer-implemented method comprising:
obtaining, via a competitor keyword identifier, a first search result ranking for a target website in association with a keyword and a second search result ranking for a competitor website of the target website in association with the keyword;
identifying, via a comparative analyzer, the keyword is a gap keyword based on a comparison of the first search result ranking for the target website and the second search result ranking for the competitor website of the target website in association with the keyword;
generating, via one or more generative artificial intelligence (AI) models, content data for the target website based on the gap keyword; and
causing display, via a user interface, of the content data.

10. The method of claim 9, wherein the keyword is identified as the gap keyword based on the first search result ranking for the target website being lower than the second search result ranking for the competitor website.

11. The method of claim 9, wherein the keyword is identified as a gap keyword based on the keyword being used by the competitor website and unused by the target website.

12. The method of claim 9, wherein generating content data for the target website comprises:
generating a prompt that includes an indication of the gap keyword and an indication of a type of content data to generate; and
providing the prompt as input to the one or more generative AI models.

13. The method of claim 9 further comprising:
causing display, via the user interface, of the gap keyword; and
obtaining a user selection, via the user interface, of the gap keyword for use in generating content data.

14. The method of claim 9, further comprising:
receiving a selection to include the displayed content data into the target website; and
including the content data into the target website by adding the content data or replacing existing content with the generated content data.

15. A computing system comprising:
a processor; and
one or more computer storage media storing computer-useable instructions that, when used by the one or more processors, causes the one or more processors to perform operations comprising:
identifying candidate performant keywords based on a comparison of search result rankings for a target website and search result rankings for one or more competitors of the target website in association with a set of keywords;
causing display of the candidate performant keywords;
based on a user selection of a candidate performant keyword, generating a content generation prompt including an indication of the candidate performant keyword as a target keyword to use in generating content data;
providing the content generation prompt as input into a generative artificial intelligence (AI) model to generate the content data including the target keyword; and
obtaining, as output from the generative AI model, the content data including the target keyword.

16. The system of claim 15, further comprising causing presentation of the content data including the target keyword.

17. The system of claim 16, further comprising:
receiving a user selection to include the content data in the target website; and
updating the target website to include the content data.

18. The system of claim 15, wherein identifying the candidate performant keywords includes identifying a first candidate performant keyword based on the target website not including a first keyword included within a competitor and identifying a second candidate performant keyword based on the target website having a lower search result ranking for a second keyword than at least one competitor.

19. The system of claim 15 further comprising obtaining the search result rankings for the target website and search result rankings for the one or more competitors of the target website in association with the set of keywords.

20. The system of claim 15, further comprising incorporating the content data into the target website to be published and used to execute subsequent searches.
